(19) United States
(12) Patent Application Publication
(10) Pub. No.: US 2023/0222344 A1
(43) Pub. Date: Jul. 13, 2023

(54) METHOD, ELECTRONIC DEVICE, AND STORAGE MEDIUM FOR DETERMINING PROMPT VECTOR OF PRE-TRAINED MODEL

(71) Applicant: BEIJING BAIDU NETCOM SCIENCE TECHNOLOGY CO., LTD., Beijing (CN)

(72) Inventors: Yekun Chai, Beijing (CN); Shuohuan Wang, Beijing (CN); Yu Sun, Beijing (CN)

(21) Appl. No.: 18/118,859

(22) Filed: Mar. 8, 2023

(30) Foreign Application Priority Data
May 14, 2022 (CN) 202210524324X

(51) Int. Cl. G06N 3/082

(52) U.S. Cl. CPC G06N 3/082

(57) ABSTRACT

A method for determining a prompt vector of a pre-trained model, includes: obtaining a first one of prompt vectors and a first vector corresponding to sample data; obtaining N pruned models by N different pruning processing on the pre-trained model, where N is any integer greater than 1; obtaining a first score corresponding to the first one of the prompt vectors by fusing the first vector and the first one of the prompt vectors and inputting the fused first vector and first one of the prompt vectors into the N pruned models respectively; determining a second one of the prompt vectors by modifying, based on the first score, the first one of the prompt vectors; and based on the second one of the prompt vectors, returning to obtaining the first score until determining a target prompt vector corresponding to the sample data.

### CROSS-REFERENCE TO RELATED APPLICATION

This application is based upon and claims priority to Chinese Patent Application No. 202210524324X, filed on May 14, 2022, the entire content of which is incorporated herein by reference.

### TECHNICAL FIELD

The disclosure relates to the field of computer technologies, in particular to the field of artificial intelligence (AI) technologies such as natural language processing (NLP) and deep learning (DL), and in particular, to a method, an apparatus, an electronic device, and a storage medium for determining a prompt vector of a pre-trained model.

### BACKGROUND

With the development of computer technologies, NLP applications are becoming more and more extensive.

### SUMMARY

In one aspect of the disclosure, a method for determining a prompt vector of a pre-trained model is provided, including: obtaining a first one of prompt vectors and a first vector corresponding to sample data; obtaining N pruned models by N different pruning processing on the pre-trained model, where N is any integer greater than 1; obtaining a first score corresponding to the first one of the prompt vectors by fusing the first vector and the first one of the prompt vectors and inputting the fused first vector and first one of the prompt vectors into the N pruned models respectively; determining a second one of the prompt vectors by modifying, based on the first score, the first one of the prompt vectors; and based on the second one of the prompt vectors, returning to obtaining the first score until determining a target prompt vector corresponding to the sample data.

In another aspect of the disclosure, an electronic device is provided, including: at least one processor; and a memory communicatively coupled to the at least one processor; in which the memory is configured to store instructions executable by the at least one processor, and the at least one processor is configured to execute the instructions to perform the above method.

In another aspect of the disclosure, a non-transitory computer-readable storage medium storing computer instructions for causing a computer to perform the above method is provided.

It should be understood that, the content described in the part is not intended to identify key or important features of embodiments of the disclosure, nor intended to limit the scope of the disclosure. Other features of the disclosure will be easy to understand through the following specification.

### BRIEF DESCRIPTION OF THE DRAWINGS

The drawings are intended to better understand solutions, and do not constitute a limitation to the disclosure.

FIG. 1 is a flowchart of a method for determining a prompt vector of a pre-trained model, according to some embodiments of the disclosure.

FIG. 2 is a flowchart of a method for determining a prompt vector of a pre-trained model, according to some embodiments of the disclosure.

FIG. 3 is a flowchart of a method for determining a prompt vector of a pre-trained model, according to some embodiments of the disclosure.

FIG. 3A is a schematic diagram of a pruned model, according to some embodiments of the disclosure.

FIG. 3B is a schematic diagram of a process for determining a prompt vector of a pre-trained model, according to some embodiments of the disclosure.

FIG. 4 is a schematic block diagram of an apparatus for determining a prompt vector of a pre-trained model, according to some embodiments of the disclosure.

FIG. 5 is a block diagram of an electronic device for implementing a method for determining a prompt vector of a pre-trained model, according to some embodiments of the disclosure.

### DETAILED DESCRIPTION

Embodiments of the disclosure are described as below with reference to the accompanying drawings, which include various details of embodiments of the disclosure to facilitate understanding, and should be considered as merely exemplary. Therefore, those skilled in the art should realize that various changes and modifications may be made to the embodiments described herein without departing from the scope and spirit of the disclosure. Similarly, for clarity and conciseness, descriptions of well-known functions and structures are omitted in the following descriptions.

AI is a subject that learns simulating by a computer certain thinking processes and intelligent behaviors (such as learning, reasoning, thinking, planning) of human beings, which covers hardware-level technologies and software-level technologies. AI hardware technologies generally include technologies such as sensors, dedicated AI chips, cloud computing, distributed storage, big data processing, etc.; and AI software technologies mainly include computer vision technology, speech recognition technology, NLP technology and machine learning (ML), DL, big data processing technology, knowledge graph (KG) technology, etc.

NLP is a cross discipline of computer science and linguistics that processes, understands and uses human languages (for example, Chinese, English) by a computer, often referred to as computational linguistics. Natural language is a fundamental symbol that human beings are different from other animals. Without language, there will be no human being's thinking.

Therefore, NLP embodies the highest task and context of AI, that is, the machine may achieve true intelligence when the machine has the ability to handle natural language.

DL refers to a multi-layered artificial neural network and a method of training it. A layer of the neural network will take a large number of matrices as input, take weights through nonlinear activation manner, and then generate another data set as output. Through the appropriate number of matrices, multiple layers of organizations are linked together to form a neural network “brain” for precise and complex processing, just like people identify objects and annotate pictures.

A method, an apparatus, an electronic device, and a storage medium for determining a prompt vector of a pre-trained model provided in some embodiments of the disclosure are described with reference to the accompanying drawings.

In the related art, a set of continuous prompt vectors can be added to an input end of a pre-trained model. And then training samples can be used to back-propagate and optimize the prompt vectors when parameters of the pre-trained model are fixed, to determine an optimal prompt vector. The prompt vector determined only through a single pre-trained model may be one-sided and inaccurate usually. Therefore, how to improve the accuracy of the prompt vector is very important.

Aiming at the problem that the prompt vector of the pre-trained model is not accurate enough in the related art, a method for determining a prompt vector of a pre-trained model is proposed in the disclosure. By fusing the first vector corresponding to the sample data and the prompt vector and inputting the fused vector into the N pruned models respectively, the corresponding first score can be obtained, and then the prompt vector can be modified based on the first score to determine the next prompt vector, and based on the newly determined prompt vector, the operation of obtaining the first score can be returned and continued until the target prompt vector is determined, so that the prompt vector can be analyzed from multiple perspectives through multiple different pruned models. The optimization can make the determined target prompt vector more comprehensive and reliable and improve the accuracy of the target prompt vector. In addition, in the disclosure, because the target prompt vector can be determined by performing forward inference on the pruned model and the prompt vector and this process does not involve back propagation and processing on the pruned model and the prompt vector, the amount of data involved is possibly less, which saves computing resources and facilitates configuration and deployment.

It should be noted that, an executive body of a method for determining a prompt vector of a pre-trained model in some embodiments is an apparatus for determining a prompt vector of a pre-trained model in some embodiments. The apparatus may be implemented by means of software and/or hardware and may be configured in an electronic device. The electronic device may include but not limited to a terminal, a server side or the like.

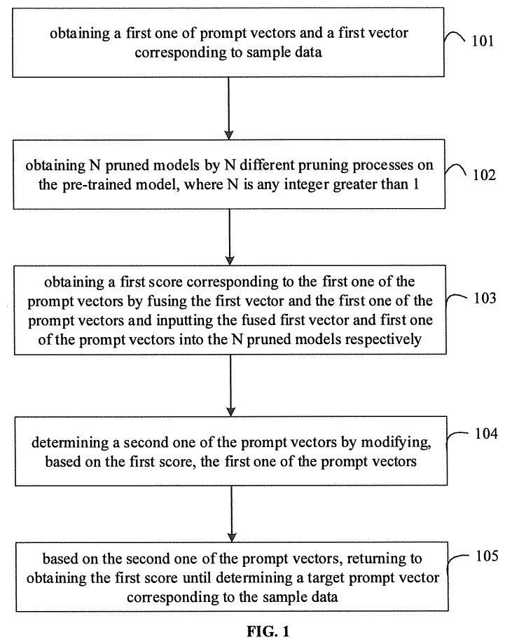

FIG. 1 is a flowchart of a method for determining a prompt vector of a pre-trained model, according to some embodiments of the disclosure.

As shown in FIG. 1, the method for determining a prompt vector of a pre-trained model includes the following steps.

In step 101, a first one of prompt vectors and a first vector corresponding to sample data are obtained.

A prompt can usually be understood as additional prompt information added to text as input, converting downstream tasks such as prediction into language model tasks and converting prediction results of the language model into original prediction results of the downstream tasks. Therefore, the prompt in some embodiments of the disclosure can be understood as prompt vector information.

The first one of the prompt vectors may be a randomly initialized vector or a prompt vector generated by sampling a set of vectors randomly in a embedding space and then linearly transforming, which is not limited in this disclosure.

In addition, the first vector may be a vector corresponding to the sample data. For example, if the sample data are a piece of text data, the first vector can be a text vector corresponding to the text data. For example, the first vector corresponding to the text data can be obtained through a vector vocabulary or in other ways, which is not limited in the disclosure.

In addition, types of sample data may be various, for example, text data, image data, audio data, or the like. In addition, there may be multiple pieces of sample data usually, for example, it can be multiple pieces of text-type sample data and each piece of sample data has its own corresponding first vector, etc.; it can be small sample data, such as only 16 or 20 pieces of samples, or large sample data, etc., which are not limited in the disclosure.

Step 102, N pruned models are obtained by N different pruning processing on the pre-trained model, where N is any integer greater than 1.

There can be many kinds of pruning processing. For example, neurons in the pre-trained model can be pruned or any other desirable pruning manner can be used to prune the pre-trained model, which is not limited in the disclosure.

In addition, the pre-trained model can be any type of pre-trained model, such as BERT (bidirectionecoder representations from transformers) or ELMo (embeddings from language models), which is not limited in the disclosure.

In addition, parameters of the pre-trained model may be many and there may be redundant parameters irrelevant to tasks. Therefore, in some embodiments of the disclosure, the pre-trained model may be pruned to obtain the pruned mode after the pruning process. It should be understood that the N different pruning processing are performed on the pre-trained model respectively to obtain the N pruned models and the N pruned models obtained are usually N pruned models that are different from each other.

S103, a first score corresponding to the first one of the prompt vectors is obtained by fusing the first vector and the first one of the prompt vectors and inputting the fused first vector and first one of the prompt vectors into the N pruned models respectively.

For example, after the first vector and the first one of the prompt vectors are fused, the fused first vector and first one of the prompt vectors can be input into the pre-trained model so that after the processing of the N pruned models, N predictive tags corresponding to the first vector can be output. That is, the predictive tags corresponding to the sample data under the N pruned models, and then each predictive tag can be matched with the tagging tag corresponding to the sample data to determine the difference between the two. Then the first score corresponding to the first one of the prompt vectors is determined based om the difference, which is not limited in the disclosure.

In addition, the first score integrates prompt vectors under multiple pruned models, which is multi-view and comprehensive, so that prompt vectors can be better predicted.

Step 104, a second one of the prompt vectors is determined by modifying, based on the first score, the first one of the prompt vectors.

For example, each element in the first one of the prompt vectors may be added to the first score, to modify the first one of the prompt vectors, and the modified vector may be determined as the second one of the prompt vectors, which is not limited in the disclosure.

Therefore, in some embodiments of the disclosure, a plurality of different pruned models after the pruning process can be used to predict the prompt vector respectively, and then the prompt vector can be optimized by using the first score including the multi-view information, so as to improve the accuracy of the prompt vector.

Step 105, based on the second one of the prompt vectors, it returns to obtaining the first score until determining a target prompt vector corresponding to the sample data.

The target prompt vector may be a relatively accurate prompt vector corresponding to the sample data, and the sample data can be processed more accurately and reliably by using the target prompt vector. Therefore, even in a small-sample learning scenario, a better learning effect can be effectively maintained. This disclosure does not limit this.

Optionally, when the specified number of training steps is reached, the above operation of obtaining the first score can be stopped or after the specified training period is reached, the above operation of obtaining the first score can be stopped, and then the target prompt vector is determined from the obtained multiple prompt vectors obtained from the training process, which is not limited in the disclosure.

For example, after the second one of the prompt vectors, the first vector corresponding to the sample data and the second one of the prompt vectors can be fused, and then the fused vector is input into the N pruned models respectively to determine the first score corresponding to the second one of the prompt vectors, and the second one of the prompt vectors can be modified based on the first score to determine a third one of the prompt vectors, and then based on the third one of the prompt vectors, it return to execute the process of obtaining the first score operation until the target prompt vector corresponding to the sample data is determined, which is not limited in the disclosure.

It can be understood that the method for determining a prompt vector of a pre-trained model provided by the disclosure can be applied to the determination of the prompt vector of any pre-trained model, such as text classification, question-and-answer pair generation, text understanding, etc. There is no limit to the disclosure.

The process of determining the prompt vector of the pre-trained model provided by the disclosure is briefly described below by taking the application to text classification as an example.

It can be understood that, the text data may be processed first to generate the first vector corresponding to the text data, and then the first one of the prompt vectors may be obtained. In addition, N can be any integer greater than 1. If the value of N is 5, when the pre-trained model is BERT, BERT can be pruned five times separately, such as pruning different neurons. to obtain 5 pruned models after pruning. After that, the first vector corresponding to the text data and the first one of the prompt vectors can be fused and input into the above five pruned models respectively. After the processing of the five pruned models, the first score corresponding to the first one of the prompt vectors can be obtained. Then, based on the first score, the first one of the prompt vectors can be modified to determine the second one of the prompt vectors; then the second one of the prompt vectors can be fused with the first vector corresponding to the text data, and then input to the above five pruned models respectively to obtain the first score corresponding to the second one of the prompt vectors; then the second one of the prompt vector can be modified based on the first score to determine the third one of the prompt vectors, and then the third one of the prompt vectors can be determined; and then based on the third one of the prompt vectors, it returns to perform the above operation of obtaining the first score, for example, which may refer to the process of obtaining the first score of the second one of the prompt vectors until the target prompt vector corresponding to the text data is determined.

It should be noted that the above example is only a schematic illustration, and may not be used as a limitation on the determination process of the prompt vector of the pre-trained model in some embodiments of the disclosure.

In some embodiments of the disclosure, a first one of prompt vectors and a first vector corresponding to sample data are obtained; N pruned models are obtained by N different pruning processing on the pre-trained model, where N is any integer greater than 1; a first score corresponding to the first one of the prompt vectors is obtained by fusing the first vector and the first one of the prompt vectors and inputting the fused first vector and first one of the prompt vectors into the N pruned models respectively; a second one of the prompt vectors is determined by modifying, based on the first score, the first one of the prompt vectors; and based on the second one of the prompt vectors, it returns to obtaining the first score until determining a target prompt vector corresponding to the sample data. Therefore, by fusing the first vector corresponding to the sample data and the prompt vector and inputting the fused vector into the N pruned models respectively, the corresponding first score can be obtained, and then the prompt vector can be modified based on the first score to determine the next prompt vector, and based on the newly determined prompt vector, the operation of obtaining the first score can be returned and continued until the target prompt vector is determined, so that the prompt vector can be analyzed from multiple perspectives through multiple different pruned models. The optimization can make the determined target prompt vector more comprehensive and reliable and improve the accuracy of the target prompt vector.

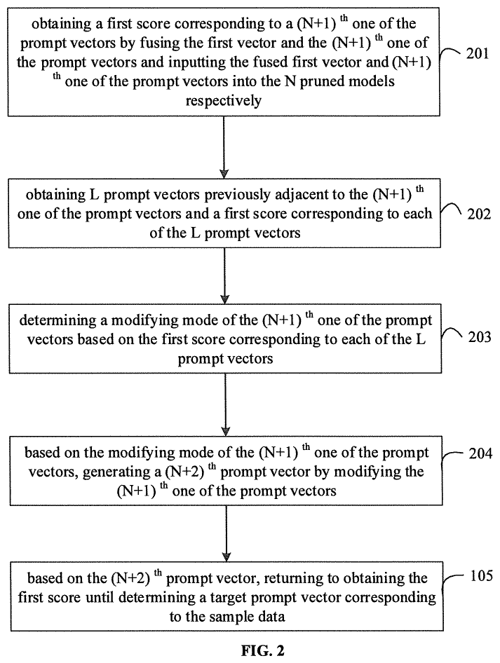

FIG. 2 is a flowchart of a method for determining a prompt vector of a pre-trained model, according to some embodiments of the disclosure.

As shown in FIG. 2, the method for determining a prompt vector of a pre-trained model includes the following steps.

Step 201, a first score corresponding to a (N+1)^{th} one of the prompt vectors is obtained by fusing the first vector and the (N+1)^{th} one of the prompt vectors and inputting the fused first vector and (N+1)^{th} one of the prompt vectors into the N pruned models respectively.

The first vector may be a vector corresponding to the sample data.

It can be understood that, in the disclosure, the first one of the prompt vectors and the first vector corresponding to the sample data can be obtained first, and then the pre-trained model can be separately pruned for N times to obtain N pruned models. After that, the first vector and the first one of the prompt vectors can be fused and input into the N pruned models respectively to obtain the first score corresponding to the first one of the prompt vectors, and then based on the first score, the first vector is modified to determine the second one of the prompt vectors, and based on the second one of the prompt vectors, it returns to performing the operations described above to obtain the first score. For example, after determining the (N+1)^{th} one of the prompt vectors, the first vector and the (N+1)^{th} one of the prompt vectors can be fused and input into the N pruned models respectively to obtain the first score corresponding to the (N+1)^{th} one of the prompt vectors.

Step 202, L prompt vectors previously adjacent to the (N+1)^{th} one of the prompt vectors and a first score corresponding to each of the L prompt vectors are obtained.

L is a positive integer less than or equal to N and greater than 1, and N is a positive integer greater than 1.

It can be understood that each prompt vector has a corresponding first score, and the first scores corresponding to different prompt vectors may be the same or may be different, which is not limited in the disclosure.

Step 203, a modifying mode of the (N+1)^{th} one of the prompt vectors is determined based on the first score corresponding to each of the L prompt vectors.

It can be understood that, if the first scores corresponding to the prompt vectors are different, the modifying mode of the (N+1)^{th} one of the prompt vectors may also be different usually.

The modifying mode may be a modifying direction of the vector or a modifying value of the vector, etc., which is not limited in the disclosure.

It can be understood that, the modifying mode of each element in the (N+1)^{th} one of the prompt vectors can be determined according to a first difference between first scores corresponding to every two adjacent prompt vectors in the L prompt vectors.

Optionally, a first difference between first scores corresponding to each two adjacent prompt vectors of the L prompt vectors is determined; when a number of positive values included in each first difference is one, a difference between each corresponding elements in two prompt vectors corresponding to the positive value is determined; and the modifying mode of each element in the (N+1)^{th} one of the prompt vectors is determined based on the difference between each corresponding elements in two prompt vectors.

For example, when N is 5 and L is 4, if the first difference between the first scores corresponding to the second one of the prompt vectors and the first one of the prompt vectors is: −7, the first difference between the first scores corresponding to the third one of the prompt vectors and the second one of the prompt vectors is: −2, and the first difference between the first scores corresponding to the fourth one of the prompt vectors and the third one of the prompt vectors is: 5, the integer value has only “5”, and the difference between the corresponding elements in the fourth one of the prompt vectors and the third one of the prompt vectors can be further determined.

If the difference between the first corresponding elements in the fourth one of the prompt vectors and in the third one of the prompt vectors is: −5, the difference between the second corresponding elements in the fourth one of the prompt vectors and in the third one of the prompt vectors is: +8, and the difference between the third corresponding elements in the fourth one of the prompt vectors and in the third one of the prompt vectors is: +11, it can be determined that in the (N+1)^{th} one of the prompt vectors, the modifying value of the first element can be a negative number, such as −2, −8, etc.; the modifying value of the second element can be a positive number, for example +3, +9, etc.; the modifying value of the third element can be a positive number, such as +6, +15, and so on. Then it can be determined that the modifying mode of the (N+1)^{th} one of the prompt vectors is: decrease, increase, increase; or it can also be determined that the modifying mode of the (N+1)^{th} one of the prompt vectors is: −3, +5, +13, etc. This disclosure does not limit this.

Optionally, a first difference between first scores corresponding to each two adjacent prompt vectors of the L prompt vectors is determined; when a number of positive values included in each first difference is multiple, a difference between each corresponding elements in two prompt vectors corresponding to a maximum positive value is determined; and the modifying mode of each element in the (N+1)¹¹¹ one of the prompt vectors is determined based on the difference between each corresponding elements in two prompt vectors.

For example, when N is 5 and L is 4, if the first difference between the first scores corresponding to the second one of the prompt vectors and the first one of the prompt vectors is: +3, the first difference between the first scores corresponding to the third one of the prompt vectors and the second one of the prompt vectors is: +10, and the first difference between the first scores corresponding to the fourth one of the prompt vectors and the third one of the prompt vectors is: −8, there are two positive values, and then the difference between the corresponding elements in the two prompt vectors corresponding to the largest positive value can be further determined, that is, the difference between the corresponding elements in the third one of the prompt vectors and the second one of the prompt vectors can be determined.

Then, the modifying mode of each element in the (N+1)^{th} one of the prompt vectors can be determined based on the difference between the corresponding elements in the third one of the prompt vectors and the second one of the prompt vectors. For example, the modifying mode of each element in the (N+1)^{th} one of the prompt vectors can be determined as the modifying direction of each element, which can be: increase, decrease, increase; or the modifying mode of each element in the (N+1)^{th} one of the prompt vectors can be determined as the modifying value of each element, for example, which can be: +2, −1, +11, etc., which are not limited in the disclosure.

It can be understood that, the first difference between the first scores corresponding to each two adjacent vectors of the L prompt vectors may contain multiple maximum positive values. At this time, the relationship between the prompt vectors corresponding to multiple maximum values and the (N+1)^{th} prompt vector can be further determined. Then the modifying mode of each element in the (N+1)^{th} one of the prompt vectors is determined.

Optionally, when the number of positive values included in each first difference is multiple, two prompt vectors corresponding to each of maximum positive values in a plurality of maximum positive values may be determined first, and a second difference between a sequence number corresponding to a latter prompt vector in the two prompt vectors and the (N+1)^{th} may be determined; and then the modifying mode of each element in the (N+1)^{th} one of the prompt vectors is determined based on a difference between each corresponding elements in two prompt vectors corresponding to a smallest second difference.

For example, when the value of N is 6 and the value of L is 5, if the first difference between the first scores corresponding to the second one of the prompt vectors and the first one of the prompt vectors is: +3, the first difference between the first scores corresponding to the third one of the prompt vectors and the second one of the prompt vectors is: +10, the first difference between the first scores corresponding to the fourth one of the prompt vectors and the third one of the prompt vectors is: −2, and the first difference between the first scores corresponding to the fifth one of the prompt vectors and the fourth one of the prompt vectors is: +10, there are two maximum positive values, and the second difference between the sequence number value corresponding to the latter prompt vector among the two prompt vectors corresponding to the maximum positive values and (N+1) may be further determined. The second difference between the third one of the prompt vectors and N+1 is: 4, and the second difference between the fifth one of the prompt vector and N+1 is: 2, and then based on the difference between the corresponding elements in the fifth one of the prompt vectors and the fourth one of the prompt vectors, corresponding to the minimum second difference “2”, the modifying mode of each element in the (N+1)^{th} one of the prompt vectors is determined, that is, the modifying mode of each element in the seventh one of the prompt vectors, which are not limited in the disclosure.

Step 204, based on the modifying mode of the (N+1)^{th} one of the prompt vectors, a (N+2)^{th} prompt vector is generated by modifying the (N+1)^{th} one of the prompt vectors.

For example, if the modifying mode of the (N+1)^{th} one of the prompt vectors is: +3, −1, +8, and the (N+1)^{th} one of the prompt vectors is: [a, b, c], the (N+2)^{th} prompt vector can be: [a+3, b−1, c+8]. Or, if the modifying mode of the (N+1)^{th} one of the prompt vectors is: increase, decrease, increase, and the (N+1)^{th} one of the prompt vectors is: [a, b, c], the (N+2)^{th} prompt vector can be: [a+10, b−5, c+13], etc., which is not limited in the disclosure.

Step 205, based on the (N+2)^{th} prompt vector, it returns to perform the above operation of obtaining the first score until the target prompt vector corresponding to the sample data is determined.

It should be noted that the method for determining a prompt vector of a pre-trained model in some embodiments can also be applied to scenarios such as text classification, question-and-answer pair generation, and text understanding. It is not repeated herein.

In some embodiments of the disclosure, the first vector and the (N+1)^{th} one of the prompt vectors can be fused and then input into the N pruned models respectively to obtain the first score corresponding to the (N+1)^{th} one of the prompt vectors. The L prompt vectors previously adjacent to the (N+1)^{th} one of the prompt vectors and the first score corresponding to each of the L prompt vectors are obtained. The modifying mode of the (N+1)^{th} one of the prompt vectors is determined based on the first score corresponding to each of the L prompt vectors. Based on the modifying mode of the (N+1)^{th} one of the prompt vectors, the (N+2)^{th} prompt vector is generated by modifying the (N+1)^{th} one of the prompt vectors. Based on the (N+2)^{th} prompt vector, it returns to continue to execute to obtain the first score until the target prompt vector is determined. Therefore, based on the different N pruned models, the L prompt vectors previously adjacent to the (N+1)^{th} one of the prompt vectors and the first score corresponding to each of the L prompt vectors are obtained. The modifying mode of the (N+1)^{th} one of the prompt vectors is determined based on the first score corresponding to each of the L prompt vectors. Based on the modifying mode of the (N+1)^{th} one of the prompt vectors, the (N+2)^{th} prompt vector is generated by modifying the (N+1)^{th} one of the prompt vectors. Based on the (N+2)^{th} prompt vector, it returns to continue to execute to obtain the first score until the target prompt vector is determined. Thus, the prompt vector can be optimized from multiple perspectives through the first scores corresponding to multiple different pruned models, which can make the determined the target prompt vector more comprehensive and reliable and improve the accuracy of the target prompt vector.

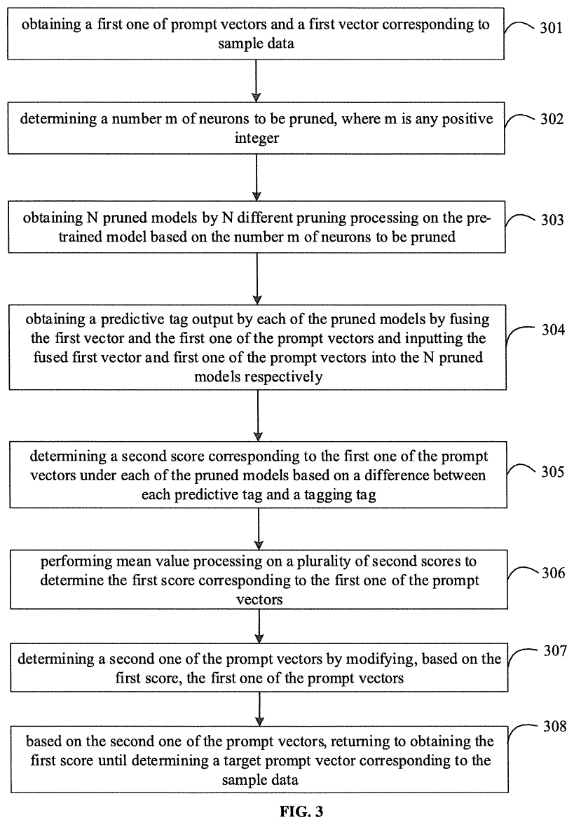

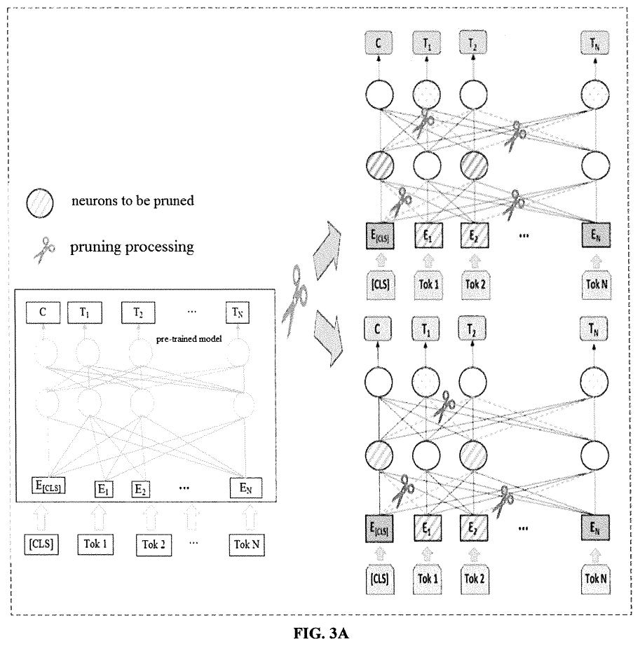

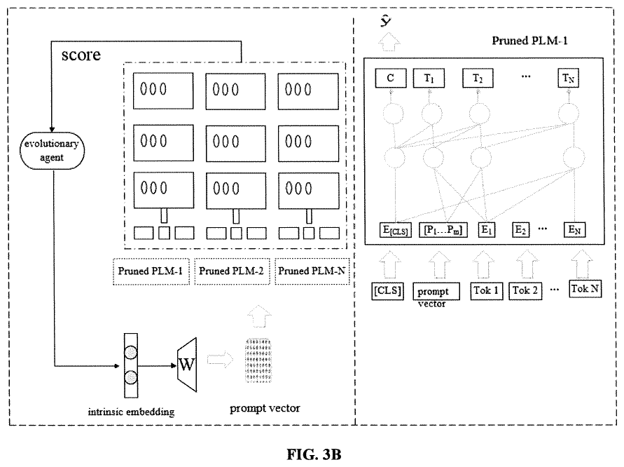

FIG. 3 is a flowchart of a method for determining a prompt vector of a pre-trained model, according to some embodiments of the disclosure.

As shown in FIG. 3, the method for determining a prompt vector of a pre-trained model includes the following steps.

Step 301, a first one of prompt vectors and a first vector corresponding to sample data are obtained.

Step 302, a number m of neurons to be pruned is determined, where m is any positive integer.

The value of m may be set in advance or adjusted during actual use, for example, it may be adjusted according to the number of neurons and layers of the pre-trained model, which is not limited in the disclosure.

Step 303, N pruned models are obtained by N different pruning processing on the pre-trained model based on the number m of neurons to be pruned.

At least one neuron between every two pruned models is different.

After determining the number m of neurons to be pruned, the pre-trained model can be separately pruned for N times and m neurons are pruned in each pruning process. At least one of the m neurons pruned in the two pruning processing is different, so that the N pruned models can be obtained, and at least one neuron is different between every two pruned models in the N pruned models.

For example, after determining the number m of neurons to be pruned, different random pruning strategies can be used to perform the N different pruning processing on the pre-trained model to obtain the N pruned models. For example, by pruning the pre-trained model differently, the two generated pruned models can be shown in FIG. 3A, where pruned neron represents the neuron to be pruned, and prune represents the pruning operation.

Alternatively, different pruning processing may also be performed according to the order of pruning. For example, starting from the first neuron in the pre-trained model, a total of m neurons can be pruned to generate the first pruned model; starting from the second neuron in the pre-trained model, a total of m neurons can be pruned to generate the second pruned model; and so on, a total of N pruning processing are performed to generate the N pruned models. Alternatively, m neurons in the first network layer in the pre-trained model can be randomly pruned to generate the first pruned model; m neurons in the second network layer in the pre-trained model can be randomly pruned to generate the second pruned model; and so on, a total of N pruning processing are performed to generate the N pruned models.

It should be noted that the above-mentioned pruning manner is only a schematic illustration, and may not be used as a limitation on the manner of obtaining the N pruned models in embodiments of the disclosure.

Therefore, in some embodiments of the disclosure, the N pruned models can be obtained by the N different pruning processing on the pre-trained model, so that parameters in the pre-trained model can be used as much as possible, improving the use efficiency of the parameters of the pre-trained model. Because the N pruned models are different, the prompt vector can be optimized from multiple perspectives and all directions, which provides a guarantee for the accuracy and reliability of the prompt vector.

Step 304, a predictive tag output by each of the pruned models is obtained by fusing the first vector and the first one of the prompt vectors and inputting the fused first vector and first one of the prompt vectors into the N pruned models respectively.

Step 305, a second score corresponding to the first one of the prompt vectors under each of the pruned models is obtained based on a difference between each predictive tag and a tagging tag.

After the first vector and the first one of the prompt vectors are fused, the fused first vector and first one of the prompt vectors can be input into the pre-trained model so that after the processing of the N pruned models, the predictive tag output by each of the pruned models is obtained. Then, each predictive tag can be matched with the tagging tag corresponding to the sample data to determine the difference between the two, and then the second score corresponding to the first one of the prompt vectors under each pruned model can be determined according to the difference.

For example, the loss function can be used to determine the loss value between the predictive tag and the tagging tag corresponding to each sample data under each pruned model, and then according to the loss value, the corresponding second score of the first one of the prompt vectors under each pruned model can be determined. Alternatively, it is also possible to determine the accuracy rate, comprehensive evaluation index, or the like according to the difference between the predictive tag and the tagging tag corresponding to each sample data under each pruned model, and use it as the second score corresponding to the first one of the prompt vectors, which is not limited in the disclosure.

Step 306, mean value processing is performed on a plurality of second scores to determine the first score corresponding to the first one of the prompt vectors.

After the respective second scores corresponding to the N pruned models are determined, the N second scores may be averaged, and the obtained result is the first score corresponding to the first one of the prompt vectors.

Optionally, other processing may also be performed on the second scores, such as variance processing, and the obtained result is the first score corresponding to the first one of the prompt vectors, which is not limited in the disclosure.

Step 307, a second one of the prompt vectors is determined by modifying, based on the first score, the first one of the prompt vectors.

Step 308, based on the second one of the prompt vectors, it returns to obtaining the first score until determining a target prompt vector corresponding to the sample data.

Optionally, in the process of determining the target prompt vector corresponding to the sample data, an evolutionary algorithm can be used such as natural evolution strategy (NES), covariance matrix adaptation evolution strategy (CMAES), to search and optimize the prompt vector; or any desirable algorithm may be used to search and optimize the prompt vector, which is not limited in the disclosure.

Optionally, in the process of determining the target prompt vector corresponding to the sample data, a sequence of candidate prompt vectors is recorded, in which a third difference between serial number values corresponding to each two adjacent candidate prompt vectors in the sequence of candidate prompt vectors is K, where K is a positive integer; a predictive tag output by each of the pruned models is obtained by fusing the second vector corresponding to verification data and each candidate prompt vector and inputting the fused first vector and each candidate prompt vector into the N pruned models respectively; a first score corresponding to each candidate prompt vector is determined based on a difference between each predictive tag and a tagging tag; and a candidate prompt vector corresponding to a first score with a highest score value is determined as the target prompt vector.

It can be understood that, after the first one of the prompt vectors, the second one of the prompt vectors, . . . , the N^{th} one of the prompt vectors are determined, multiple candidate prompt vectors may be selected from there prompt vectors. For example, there are 50 prompt vectors in total, and when the third difference K is 10, the first one of the prompt vectors, the 11^{th} one of the prompt vectors, the 21^{st} one of the prompt vectors, the 31^{st} one of the prompt vectors, and the 41^{st} one of the prompt vectors are used as candidate prompt vectors to form the sequence of candidate prompt vectors; or the 3^{rd} one of the prompt vectors, the 13^{th} one of the prompt vectors, the 23^{rd} one of the prompt vectors, the 33^{rd} one of the prompt vectors, and the 43^{rd} one of the prompt vectors can be used as candidate prompt vectors, or the like, which are not limited in the disclosure.

In addition, the second vector may be a vector corresponding to the verification data; there may be various manners for the fusion of the second vector and the candidate prompt vector. For example, the two may be spliced and fused or may be fused in other manners, which is not limited in the disclosure.

It can be understood that the second vector and the candidate prompt vector can be fused and input into the N pruned models respectively, so that after the processing of the N pruned models, the second vector, that is, the predictive tag corresponding to the verification data, is output. Then, the predictive tag can be matched with the tagging tag corresponding to the verification data to determine the difference between the two, and then the first score corresponding to the candidate prompt vector can be determined according to the difference. For example, the loss function can be used to determine the loss value between the predictive tag and the tagging tag, and then the corresponding first score is determined according to the loss value. Alternatively, the accuracy rate, the comprehensive evaluation index, or the like may also be determined according to the difference between the predictive tag and the tagging tag, and used as the corresponding first score, which is not limited in the disclosure.

For example, if the first score corresponding to the candidate prompt vector 1 is: +7, the first score corresponding to the candidate prompt vector 2 is: −3, and the first score corresponding to the candidate prompt vector 3 is: +9, the “candidate prompt vector 3” is determined to be the target prompt vector, which is not limited in the disclosure.

It should be noted that the above examples are only schematic descriptions, and may not be used as limitations on the manner of determining the target prompt vector in embodiments of the disclosure.

It can be understood that the method for determining a prompt vector of a pre-trained model provided by the disclosure can be applied to the determination of the prompt vector of any pre-trained model, such as text classification, question-and-answer pair generation, text understanding, etc. There is no limit to the disclosure.

Taking text classification as an example, the process of determining the prompt vector of the pre-trained model provided by the disclosure will be described with reference to FIG. 3B.

First, a set of intrinsic embeddings can be randomly sampled in the embedding space and then subjected to linear processing W to generate the first one of the prompt vectors. After that, the first one of the prompt vectors [P₁ . . . Pₘ] can be fused with the first vector [E₁ E₂ . . . E_{N}] corresponding to the text data [Tok 1 Tok 2 . . . Tok N], and then input them into the N pruned models (that is, Pruned PLM-1 to PLM-N) respectively, to obtain the first score corresponding to the first one of the prompt vectors. Based on the first score, the first one of the prompt vectors can be modified to determine the second one of the prompt vectors. Based on the second one of the prompt vectors, it may return to execute the above operation of obtaining the first score until the target prompt vector corresponding to the text data is determined.

Optionally, an evolutionary learning algorithm (evolutionary agent) can also be used to parse the first score to output a corresponding vector, and then perform linear transformation to generate a prompt vector, which is not limited in this disclosure.

In addition, the first one of the prompt vectors can be fused with the first vector corresponding to the text data, for example, the first one of the prompt vectors [P₁ . . . Pₘ] can be spliced into the left side of the first vector [E₁ E₂ . . . E_{N}] corresponding to the text data [Tok 1 Tok 2 . . . Tok N], which can then be imported into the 1^{st} pruned model. E_{[CLS]} can also be used as the fusion vector of the first one of the prompt vectors and the first vector corresponding to the text data, and input it into the first pruned model Pruned PLM-1, so as to pass the first pruned model. For the processing of the pruned model, for example, the input [CLS] can be processed by a linear classifier, and then the predictive tag Y can be matched with the tag y corresponding to the text data to determine the second score corresponding to the first one of the prompt vectors in the first pruned model. Similarly, the first one of the prompt vectors can be fused with the first vector corresponding to the text data, and then input into the remaining pruned models to obtain multiple second scores, and then the multiple second scores can be averaged to generate the first score corresponding to the first one of the prompt vectors.

Afterwards, the first score can be analytically processed using an evolutionary learning algorithm to output the corresponding vector, which is then linearly transformed to generate the second one of the prompt vectors. Afterwards, based on the second one of the prompt vectors, the above operation of obtaining the first score can be returned to until the target prompt vector corresponding to the text data is determined.

There may be various situations in the process of returning to perform the above operation of obtaining the first score.

The operation of obtaining the first score is briefly described below by taking the value of N as 5 as an example.

For example, when the value of N is 5 and the value of L is 4, the first four prompt vectors adjacent to the sixth one of the prompt vectors and the corresponding first scores can be obtained first, that is, the first score corresponding to the second one of the prompt vectors, the first score corresponding to the third one of the prompt vector, the first score corresponding to the fourth one of the prompt vectors, and the first score corresponding to the fifth one of the prompt vectors. Based on the first score corresponding to each prompt vector in these 4 prompt vectors, the modifying mode of the sixth one of the prompt vectors is determined. Based on the modifying mode, the sixth one of the prompt vectors is modified to generate the seventh one of the prompt vectors. Afterwards, based on the seventh one of the prompt vectors, the above operation of obtaining the first score may be returned to, until the target prompt vector is determined. It should be noted that the above examples are only schematic descriptions, and may not be used as limitations on the manner of determining the target prompt vector in the embodiments of the disclosure.

In some embodiments of the disclosure, the first one of the prompt vectors and the first vector corresponding to the sample data can be obtained first. The number m of neurons to be pruned can be determined, and based on the number m of neurons to be pruned, N different pruning processing are performed respectively on the pre-trained model to obtain the N pruned models. After that, the first vector and the first one of the prompt vectors can be fused and input into the N pruned models respectively to obtain the predictive tag output by each pruned model. The predictive tag output by each pruned model can be used to determine the second score corresponding to the first one of the prompt vectors under each pruned model based on the difference between each predictive tag and the tagging tag, and then multiple second scores can be calculated. The mean value is processed on the multiple second scores to determine the first score corresponding to the first one of the prompt vectors, and then the first one of the prompt vectors can be modified based on the first score to determine the second one of the prompt vectors, and then based on the second one of the prompt vectors, it returns to the above operation of obtaining the first score until the target prompt vector corresponding to the sample data is determined. Therefore, by fusing the first vector corresponding to the sample data and the prompt vector and inputting them into the N pruned models respectively, the corresponding first score can be obtained, and then the prompt vector can be modified based on the first score to determine the next prompt vector, and then based on the newly determined prompt vector, the operation of obtaining the first score can be returned to continue until the target prompt vector is determined, so that the prompt vector can be analyzed from multiple perspectives through multiple different pruned models. The optimization can make the determined target prompt vector more comprehensive and reliable and improve the accuracy of the target prompt vector.

To implement the above embodiments, the disclosure also provides an apparatus for determining a prompt vector of a pre-trained model.

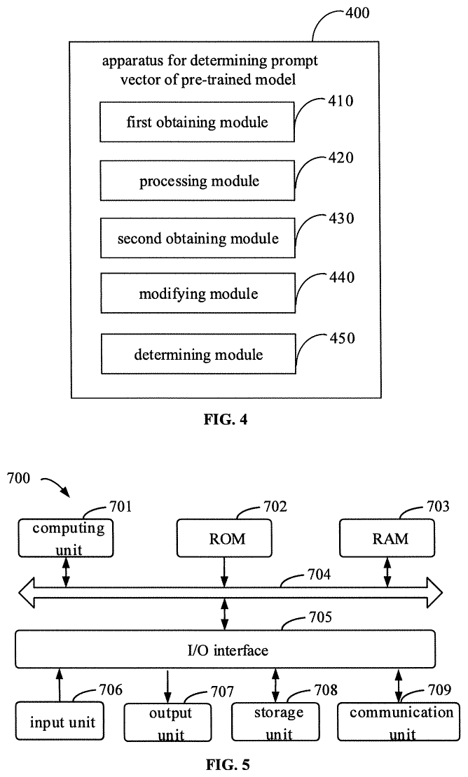

FIG. 4 is a schematic structural diagram of an apparatus for determining a prompt vector of a pre-trained model according to some embodiments of the disclosure.

As shown in FIG. 4, the apparatus 400 for determining a prompt vector of a pre-trained model includes a first obtaining module 410, a processing module 420, a second obtaining module 430, a modification module 440 and a determining module 450.

The first obtaining module 410 is configured to obtain a first one of prompt vectors and a first vector corresponding to sample data.

The processing module 420 is configured to obtain N pruned models by N different pruning processing on the pre-trained model, where N is any integer greater than 1.

The second obtaining module 430 is configured to obtain a first score corresponding to the first one of the prompt vectors by fusing the first vector and the first one of the prompt vectors and inputting the fused first vector and first one of the prompt vectors into the N pruned models respectively.

The modification module 440 is configured to determine a second one of the prompt vectors by modifying, based on the first score, the first one of the prompt vectors.

The determining module 450 is configured to, based on the second one of the prompt vectors, return to obtaining the first score until determining a target prompt vector corresponding to the sample data.

Optionally, the determining module 450 includes: an obtaining unit, configured to obtain L prompt vectors previously adjacent to a (N+1)^{th} one of the prompt vectors and a first score corresponding to each of the L prompt vectors, where L is a positive integer less than or equal to N and greater than 1, and N is a positive integer greater than 1; a determining unit, configured to determine a modifying mode of the (N+1)^{th} one of the prompt vectors based on the first score corresponding to each of the L prompt vectors; and a generating unit, configured to, based on the modifying mode of the (N+1)^{th} one of the prompt vectors, generate a (N+2)^{th} prompt vector by modifying the (N+1)^{th} one of the prompt vectors.

Optionally, the determining unit is configured to: determine a first difference between first scores corresponding to each two adjacent prompt vectors of the L prompt vectors; when a number of positive values included in each first difference is one, determine a difference between each corresponding elements in two prompt vectors corresponding to the positive value; and determine the modifying mode of each element in the (N+1)^{th} one of the prompt vectors based on the difference between each corresponding elements in two prompt vectors.

Optionally, the determining unit is configured to: determine a first difference between first scores corresponding to each two adjacent prompt vectors of the L prompt vectors; when a number of positive values included in each first difference is multiple, determine a difference between each corresponding elements in two prompt vectors corresponding to a maximum positive value; and determine the modifying mode of each element in the (N+1)^{th} one of the prompt vectors based on the difference between each corresponding elements in two prompt vectors.

Optionally, the determining unit is further configured to: when the number of positive values included in each first difference is multiple, determine two prompt vectors corresponding to each of maximum positive values in a plurality of maximum positive values; determine a second difference between a sequence number corresponding to a latter prompt vector in the two prompt vectors and the (N+1)^{th}; and determine the modifying mode of each element in the (N+1)^{th} one of the prompt vectors based on a difference between each corresponding elements in two prompt vectors corresponding to a smallest second difference.

Optionally, the second obtaining module 430 is configured to: obtain a predictive tag output by each of the pruned models by fusing the first vector and the first one of the prompt vectors and inputting the fused first vector and first one of the prompt vectors into the N pruned models respectively; determine a second score corresponding to the first one of the prompt vectors under each of the pruned models based on a difference between each predictive tag and a tagging tag; and perform mean value processing on a plurality of second scores to determine the first score corresponding to the first one of the prompt vectors.

Optionally, the determining module 450 is configured to: record a sequence of candidate prompt vectors, in which a third difference between serial number values corresponding to each two adjacent candidate prompt vectors in the sequence of candidate prompt vectors is K, where K is a positive integer; obtain a predictive tag output by each of the pruned models by fusing the second vector corresponding to verification data and each candidate prompt vector and inputting the fused first vector and each candidate prompt vector into the N pruned models respectively; determine a first score corresponding to each candidate prompt vector based on a difference between each predictive tag and a tagging tag; and determine a candidate prompt vector corresponding to the first score with a highest score value as the target prompt vector.

Optionally, the first obtaining module 410 is configured to: determine a number m of neurons to be pruned, where in is any positive integer; and obtain the N pruned models by the N different pruning processing on the pre-trained model based on the number m of neurons to be pruned, in which at least one neuron between every two pruned models is different.

For functions and implementation principles of the foregoing modules in embodiments of the disclosure, reference may be made to the foregoing method embodiments, and details are not described herein again.

The apparatus for determining a prompt vector of a pre-trained model provided by the disclosure can first obtain a first one of prompt vectors and a first vector corresponding to sample data; obtain N pruned models by N different pruning processing on the pre-trained model, where N is any integer greater than 1; obtain a first score corresponding to the first one of the prompt vectors by fusing the first vector and the first one of the prompt vectors and inputting the fused first vector and first one of the prompt vectors into the N pruned models respectively; determine a second one of the prompt vectors by modifying, based on the first score, the first one of the prompt vectors; and based on the second one of the prompt vectors, return to obtaining the first score until determining a target prompt vector corresponding to the sample data. Therefore, by fusing the first vector corresponding to the sample data and the prompt vector and inputting the fused vector into the N pruned models respectively, the corresponding first score can be obtained, and then the prompt vector can be modified based on the first score to determine the next prompt vector, and based on the newly determined prompt vector, the operation of obtaining the first score can be returned and continued until the target prompt vector is determined, so that the prompt vector can be analyzed from multiple perspectives through multiple different pruned models. The optimization can make the determined target prompt vector more comprehensive and reliable and improve the accuracy of the target prompt vector.

An electronic device, a readable storage medium and a computer program product are further provided according to embodiments of the disclosure.

FIG. 5 is a schematic block diagram illustrating an example electronic device 500 in some embodiments of the disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 5, a device 500 includes a computing unit 501, configured to execute various appropriate actions and processing according to a computer program stored in a read-only memory (ROM) 502 or loaded from a memory unit 508 to a random access memory (RAM) 503. In a RAM 503, various programs and data required for a device 500 may be stored. A computing unit 501, a ROM 502 and a RAM 503 may be connected with each other by a bus 504. An input/output (I/O) interface 505 is also connected to a bus 504.

A plurality of components in the device 500 are connected to an I/O interface 505, and includes: an input unit 506, for example, a keyboard, a mouse, etc.; an output unit 507, for example various types of displays, speakers; a memory unit 508, for example a magnetic disk, an optical disk; and a communication unit 509, for example, a network card, a modem, a wireless transceiver. A communication unit 509 allows a device 500 to exchange information/data through a computer network such as internet and/or various types of telecommunication networks and other devices.

A computing unit 501 may be various types of general and/or dedicated processing components with processing and computing ability. Some examples of a computing unit 501 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 501 executes various methods and processing as described above, for example, a method for generating a cross-lingual textual semantic model or a method for determining a textual semantic. For example, in some embodiments, the method for generating a cross-lingual textual semantic model or the method for determining a textual semantic may be further implemented as a computer software program, which is physically contained in a machine readable medium, such as a storage unit 508. In some embodiments, a part or all of the computer program may be loaded and/or installed on the device 500 through a ROM 502 and/or a communication unit 509. When the computer program is loaded on a RAM 503 and executed by a computing unit 501, one or more blocks in the method for generating a cross-lingual textual semantic model or the method for determining a textual semantic as described above may be performed. Alternatively, in other embodiments, a computing unit 501 may be configured to perform a method for generating cross-lingual textual semantic model or a method for determining a textual semantic in other appropriate ways (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), a system on a chip (SoC), a load programmable logic device (CPLD), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the disclosure may be written with one or any combination of multiple programming languages. These programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be executed completely or partly on the machine, executed partly on the machine as an independent software package and executed partly or completely on the remote machine or server.

In the context of the disclosure, a machine-readable medium may be a tangible medium that may contain or store a program intended for use in or in conjunction with an instruction execution system, apparatus, or device. A machine-readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an erasable programmable read-only memory (an EPROM or a flash memory), an optical fiber device, and a portable optical disk read-only memory (CDROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relation between the client and the server is generated by computer programs that run on the corresponding computer and have a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

The solution of some embodiments of the disclosure, can first obtain a first one of prompt vectors and a first vector corresponding to sample data; obtain N pruned models by N different pruning processing on the pre-trained model, where N is any integer greater than 1; obtain a first score corresponding to the first one of the prompt vectors by fusing the first vector and the first one of the prompt vectors and inputting the fused first vector and first one of the prompt vectors into the N pruned models respectively; determine a second one of the prompt vectors by modifying, based on the first score, the first one of the prompt vectors; and based on the second one of the prompt vectors, return to obtaining the first score until determining a target prompt vector corresponding to the sample data. Therefore, by fusing the first vector corresponding to the sample data and the prompt vector and inputting the fused vector into the N pruned models respectively, the corresponding first score can be obtained, and then the prompt vector can be modified based on the first score to determine the next prompt vector, and based on the newly determined prompt vector, the operation of obtaining the first score can be returned and continued until the target prompt vector is determined, so that the prompt vector can be analyzed from multiple perspectives through multiple different pruned models. The optimization can make the determined target prompt vector more comprehensive and reliable and improve the accuracy of the target prompt vector.

It should be understood that, various forms of procedures shown above may be configured to reorder, add or delete blocks. For example, blocks described in the disclosure may be executed in parallel, sequentially, or in a different order, as long as the desired result of the technical solution disclosed in the disclosure may be achieved, which will not be limited herein.

In addition, the terms “first” and “second” used in the disclosure are only for description purpose, and may not be understood as relative importance of indication or implication or number of technical features indicated by implication. Therefore, features limiting “first “and “second “may explicitly or implicitly include at least one of the features. In the description of the disclosure, “a plurality of” means at least two, for example two, three, etc., unless otherwise specified. In the description of the disclosure, “if “and “on condition that” as used herein may be interpreted as “when” or “in response to determination” or “in case that”.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the spirit and principle of embodiments of the disclosure shall be included within the protection scope of embodiments of the disclosure.

1. A method for determining a prompt vector of a pre-trained model, comprising:
obtaining a first one of prompt vectors and a first vector corresponding to sample data;
obtaining N pruned models by N different pruning processing on the pre-trained model, where N is any integer greater than 1;
obtaining a first score corresponding to the first one of the prompt vectors by fusing the first vector and the first one of the prompt vectors and inputting the fused first vector and first one of the prompt vectors into the N pruned models respectively;
determining a second one of the prompt vectors by modifying, based on the first score, the first one of the prompt vectors; and
based on the second one of the prompt vectors, returning to obtaining the first score until determining a target prompt vector corresponding to the sample data.

2. The method of claim 1, wherein returning to obtaining the first score comprises:
obtaining L prompt vectors previously adjacent to a (N+1)^{th} one of the prompt vectors and a first score corresponding to each of the L prompt vectors, where L is a positive integer less than or equal to N and greater than 1, and N is a positive integer greater than 1;
determining a modifying mode of the (N+1)^{th} one of the prompt vectors based on the first score corresponding to each of the L prompt vectors; and
based on the modifying mode of the (N+1)^{th} one of the prompt vectors, generating a (N+2)^{th} prompt vector by modifying the (N+1)^{th} one of the prompt vectors.

3. The method of claim 2, wherein determining the modifying mode of the (N+1)^{th} one of the prompt vectors based on the first score corresponding to each of the L prompt vectors comprises:
determining a first difference between first scores corresponding to each two adjacent prompt vectors of the L prompt vectors;
when a number of positive values included in each first difference is one, determining a difference between each corresponding elements in two prompt vectors corresponding to the positive value; and
determining the modifying mode of each element in the (N+1)^{th} one of the prompt vectors based on the difference between each corresponding elements in two prompt vectors.

4. The method of claim 2, wherein determining the modifying mode of the (N+1)^{th} one of the prompt vectors based on the first score corresponding to each of the L prompt vectors comprises:
determining a first difference between first scores corresponding to each two adjacent prompt vectors of the L prompt vectors;
when a number of positive values included in each first difference is multiple, determining a difference between each corresponding elements in two prompt vectors corresponding to a maximum positive value; and
determining the modifying mode of each element in the (N+1)^{th} one of the prompt vectors based on the difference between each corresponding elements in two prompt vectors.

5. The method of claim 2, wherein determining the modifying mode of the (N+1)^{th} one of the prompt vectors based on the first score corresponding to each of the L prompt vectors comprises:
determining a first difference between first scores corresponding to each two adjacent prompt vectors of the L prompt vectors;
when a number of positive values included in each first difference is multiple, determining two prompt vectors corresponding to each of maximum positive values in a plurality of maximum positive values;
determining a second difference between a sequence number corresponding to a latter prompt vector in the two prompt vectors and the (N+1)^{th}; and
determining the modifying mode of each element in the (N+1)^{th} one of the prompt vectors based on a difference between each corresponding elements in two prompt vectors corresponding to a smallest second difference.

6. The method of claim 1, wherein obtaining the first score corresponding to the first one of the prompt vectors by fusing the first vector and the first one of the prompt vectors and inputting the fused first vector and first one of the prompt vectors into the N pruned models respectively comprises:
obtaining a predictive tag output by each of the pruned models by fusing the first vector and the first one of the prompt vectors and inputting the fused first vector and first one of the prompt vectors into the N pruned models respectively;
determining a second score corresponding to the first one of the prompt vectors under each of the pruned models based on a difference between each predictive tag and a tagging tag; and
performing mean value processing on a plurality of second scores to determine the first score corresponding to the first one of the prompt vectors.

7. The method of claim 1, wherein determining the target prompt vector corresponding to the sample data comprises:
recording a sequence of candidate prompt vectors, wherein a third difference between serial number values corresponding to each two adjacent candidate prompt vectors in the sequence of candidate prompt vectors is K, where K is a positive integer;
obtaining a predictive tag output by each of the pruned models by fusing the second vector corresponding to verification data and each candidate prompt vector and inputting the fused first vector and each candidate prompt vector into the N pruned models respectively;
determining a first score corresponding to each candidate prompt vector based on a difference between each predictive tag and a tagging tag; and
determining a candidate prompt vector corresponding to a first score with a highest score value as the target prompt vector.

8. The method of claim 1, wherein obtaining the N pruned models by the N different pruning processing on the pre-trained model comprises:
determining a number m of neurons to be pruned, where m is any positive integer; and
obtaining the N pruned models by the N different pruning processing on the pre-trained model based on the number m of neurons to be pruned, wherein at least one neuron between every two pruned models is different.

9. An electronic device, comprising:
a processor; and
a memory communicatively coupled to the processor;
wherein, the memory is configured to store instructions executable by the processor, and the processor is configured to execute the instructions to:
obtain a first one of prompt vectors and a first vector corresponding to sample data;
obtain N pruned models by N different pruning processing on the pre-trained model, where N is any integer greater than 1;
obtain a first score corresponding to the first one of the prompt vectors by fusing the first vector and the first one of the prompt vectors and inputting the fused first vector and first one of the prompt vectors into the N pruned models respectively;
determine a second one of the prompt vectors by modifying, based on the first score, the first one of the prompt vectors; and
based on the second one of the prompt vectors, return to obtaining the first score until determining a target prompt vector corresponding to the sample data.

10. The device of claim 9, wherein the processor is further configured to execute the instructions to:
obtain L prompt vectors previously adjacent to a (N+1)^{th} one of the prompt vectors and a first score corresponding to each of the L prompt vectors, where L is a positive integer less than or equal to N and greater than 1, and N is a positive integer greater than 1;
determine a modifying mode of the (N+1)^{th} one of the prompt vectors based on the first score corresponding to each of the L prompt vectors; and
based on the modifying mode of the (N+1)^{th} one of the prompt vectors, generate a (N+2)^{th} prompt vector by modifying the (N+1)^{th} one of the prompt vectors.

11. The device of claim 10, wherein the processor is further configured to execute the instructions to:
determine a first difference between first scores corresponding to each two adjacent prompt vectors of the L prompt vectors;
when a number of positive values included in each first difference is one, determine a difference between each corresponding elements in two prompt vectors corresponding to the positive value; and
determine the modifying mode of each element in the (N+1)^{th} one of the prompt vectors based on the difference between each corresponding elements in two prompt vectors.

12. The device of claim 10, wherein the processor is further configured to execute the instructions to:
determine a first difference between first scores corresponding to each two adjacent prompt vectors of the L prompt vectors;
when a number of positive values included in each first difference is multiple, determine a difference between each corresponding elements in two prompt vectors corresponding to a maximum positive value; and
determine the modifying mode of each element in the (N+1)^{th} one of the prompt vectors based on the difference between each corresponding elements in two prompt vectors.

13. The device of claim 10, wherein the processor is further configured to execute the instructions to:
determine a first difference between first scores corresponding to each two adjacent prompt vectors of the L prompt vectors;
when a number of positive values included in each first difference is multiple, determine two prompt vectors corresponding to each of maximum positive values in a plurality of maximum positive values;
determine a second difference between a sequence number corresponding to a latter prompt vector in the two prompt vectors and the (N+1)^{th}; and
determine the modifying mode of each element in the (N+1)^{th} one of the prompt vectors based on a difference between each corresponding elements in two prompt vectors corresponding to a smallest second difference.

14. The device of claim 9, wherein the processor is further configured to execute the instructions to:
obtain a predictive tag output by each of the pruned models by fusing the first vector and the first one of the prompt vectors and inputting the fused first vector and first one of the prompt vectors into the N pruned models respectively;
determine a second score corresponding to the first one of the prompt vectors under each of the pruned models based on a difference between each predictive tag and a tagging tag; and
perform mean value processing on a plurality of second scores to determine the first score corresponding to the first one of the prompt vectors.

15. The device of claim 9, wherein the processor is further configured to execute the instructions to:
record a sequence of candidate prompt vectors, wherein a third difference between serial number values corresponding to each two adjacent candidate prompt vectors in the sequence of candidate prompt vectors is K, where K is a positive integer;
obtain a predictive tag output by each of the pruned models by fusing the second vector corresponding to verification data and each candidate prompt vector and inputting the fused first vector and each candidate prompt vector into the N pruned models respectively;
determine a first score corresponding to each candidate prompt vector based on a difference between each predictive tag and a tagging tag; and
determine a candidate prompt vector corresponding to a first score with a highest score value as the target prompt vector.

16. The device of claim 9, wherein the processor is further configured to execute the instructions to:
determine a number m of neurons to be pruned, where m is any positive integer; and
obtain the N pruned models by the N different pruning processing on the pre-trained model based on the number m of neurons to be pruned, wherein at least one neuron between every two pruned models is different.

17. A non-transitory computer-readable storage medium storing computer instructions for causing a computer to perform a method for determining a prompt vector of a pre-trained model, the method comprising:
obtaining a first one of prompt vectors and a first vector corresponding to sample data;
obtaining N pruned models by N different pruning processing on the pre-trained model, where N is any integer greater than 1;
obtaining a first score corresponding to the first one of the prompt vectors by fusing the first vector and the first one of the prompt vectors and inputting the fused first vector and first one of the prompt vectors into the N pruned models respectively;
determining a second one of the prompt vectors by modifying, based on the first score, the first one of the prompt vectors; and
based on the second one of the prompt vectors, returning to obtaining the first score until determining a target prompt vector corresponding to the sample data.

18. The non-transitory computer-readable storage medium of claim 17, wherein returning to obtaining the first score comprises:
obtaining L prompt vectors previously adjacent to a (N+1)^{th} one of the prompt vectors and a first score corresponding to each of the L prompt vectors, where L is a positive integer less than or equal to N and greater than 1, and N is a positive integer greater than 1;
determining a modifying mode of the (N+1)^{th} one of the prompt vectors based on the first score corresponding to each of the L prompt vectors; and
based on the modifying mode of the (N+1)^{th} one of the prompt vectors, generating a (N+2)^{th} prompt vector by modifying the (N+1)^{th} one of the prompt vectors.

19. The non-transitory computer-readable storage medium of claim 18, wherein determining the modifying mode of the (N+1)^{th} one of the prompt vectors based on the first score corresponding to each of the L prompt vectors comprises:
determining a first difference between first scores corresponding to each two adjacent prompt vectors of the L prompt vectors;
when a number of positive values included in each first difference is one, determining a difference between each corresponding elements in two prompt vectors corresponding to the positive value; and
determining the modifying mode of each element in the (N+1)^{th} one of the prompt vectors based on the difference between each corresponding elements in two prompt vectors.

20. The non-transitory computer-readable storage medium of claim 18, wherein determining the modifying mode of the (N+1)^{th} one of the prompt vectors based on the first score corresponding to each of the L prompt vectors comprises:
determining a first difference between first scores corresponding to each two adjacent prompt vectors of the L prompt vectors;
when a number of positive values included in each first difference is multiple, determining a difference between each corresponding elements in two prompt vectors corresponding to a maximum positive value; and
determining the modifying mode of each element in the (N+1)^{th} one of the prompt vectors based on the difference between each corresponding elements in two prompt vectors.
